(19) United States
(12) Patent Application Publication
(10) Pub. No.: US 2026/0307806 A1
(43) Pub. Date: Oct. 8, 2026

(54) MONUMENT TRAY TABLE WITH SLOT

(71) Applicant: B/E Aerospace, Inc., Winston-Salem, NC (US)

(72) Inventors: Kyle Nathen Swen, Crystal Lake, IL (US); Travis John Vaninetti, Bothell, WA (US); Travis K. Finlay, Durham, NC (US); Christopher D. Adcock, Advance, NC (US)

(73) Assignee: B/E Aerospace, Inc., Winston-Salem, NC (US)

(21) Appl. No.: 19/636,736

(22) Filed: Apr. 1, 2026

Related U.S. Application Data
(60) Provisional application No. 63/783,441, filed on Apr. 4, 2025.
(60) Provisional application No. 63/783,437, filed on Apr. 4, 2025.

(51) Int. Cl. B64D 11/06; A47B 5/00; A47B 5/04; B64D 11/00

(52) U.S. Cl. CPC B64D 11/0638; A47B 5/006; A47B 5/04; B64D 11/0015

(57) ABSTRACT

An aircraft monument may comprise a vertical pocket for retaining a tray table. An extendible arm of the tray table may rotate about a first axis to extend the tray table from the vertical pocket. A rotatable shelf coupled to the extendible arm may rotate between a horizontal position, a vertical position, and an obtuse position. The tray table may be configured to receive a portable electronic device (PED) into an elongated slot extending into a top surface of the rotatable shelf. The tray table may be configured to receive the PED into an electronic device shelf disposed on an opposing side of the rotatable shelf from the elongated slot. The rotatable shelf may comprise a depressed surface extending into the top surface and spaced from the elongated slot.

### CROSS REFERENCE TO RELATED APPLICATIONS

This application claims the benefit and priority of U.S. Provisional Application Number 63/783,441, entitled “MONUMENT TRAY TABLE WITH SLOT,” filed on Apr. 4, 2025, and U.S. Provisional Application Number 63/783,437, entitled “MONUMENT TRAY TABLE ROTATABLE SHELF,” filed on Apr. 4, 2025, both of which are hereby incorporated by reference in their entirety for all purposes.

### TECHNICAL FIELD

The present disclosure relates generally to a tray table and, more particularly, to a rotatable tray table with an elongated slot and rotatable from an aircraft monument.

### BACKGROUND

Aircraft passengers are increasingly using personal electronic devices in aircraft seats. Hands-free shelves for portable electronic devices (PED) are typically disposed on the back of aircraft seats or on a top side of a tray table deployable from an aircraft seat. Wheelchair plinths are typically disposed facing open spaces, such as an aisle, and are typically not aft of a seat or a wall. Trays deployed from the back of aircraft seats may not be compatible with wheelchair plinths.

### SUMMARY

In one aspect, an aircraft monument is disclosed. The aircraft monument may comprise a tray table having an extendible arm configured to rotate about a first axis between a stowed position and a deployed position, a rotatable shelf coupled to the extendible arm and configured to rotate about a second axis perpendicular to the first axis, and an elongated slot extending into a top surface of the rotatable shelf.

In various embodiments, the elongated slot may be disposed parallel to the second axis and comprises a plurality of drainage holes.

In various embodiments, the elongated slot may have a first longitudinal wall, a second longitudinal wall, and a pair of end walls each coupling the first longitudinal wall to the second longitudinal wall. In various embodiments, the second longitudinal wall forms an obtuse angle with the top surface.

In various embodiments, the aircraft monument may comprise an electronic device shelf disposed on a bottom side of the rotatable shelf.

In various embodiments, the aircraft monument may comprise a depressed surface. In various embodiments, the elongated slot may be disposed between the depressed surface and the second axis.

In various embodiments, the depressed surface may have a first depth and the elongated slot may have a second depth. In various embodiments, the second depth may be greater than the first depth.

In various embodiments, a perimeter of the depressed surface may be defined by the top surface of the rotatable shelf.

In various embodiments, in response to being rotated about the first axis to a horizontal position, the extendible arm may be extendible along the second axis.

In another aspect, an aircraft monument is disclosed. The aircraft monument may comprise a tray table rotatable about a first axis between a stowed position and a first deployed position and configured to receive a portable electronic device (PED). The aircraft monument may comprise a vertical pocket configured to stow the tray table in a stowed position.

In various embodiments, the tray table may be configured to receive the PED into an elongated slot extending into a top surface of the tray table.

In various embodiments, the tray table may be configured to receive the PED into an electronic device shelf rotatable from a bottom side of the tray table.

In various embodiments, in response to being rotated to the first deployed position, the tray table may be rotatable about a second axis between a horizontal position and an obtuse position.

In various embodiments, the aircraft monument may comprise a depressed surface extending into the top surface. In various embodiments, the depressed surface spaced from the elongated slot.

In various embodiments, the top surface may define a perimeter of the depressed surface.

In various embodiments, the depressed surface may have a greater width than the elongated slot. In various embodiments, the elongated slot may have a greater depth than the depressed surface.

In another aspect, a tray table system is disclosed. The tray table system may comprise an extendible arm; and a rotatable shelf coupled to the extendible arm along a longitudinal edge of the rotatable shelf such that the extendible arm protrudes beyond a proximate end of the rotatable shelf and terminates at a distal end of the rotatable shelf and such that the rotatable shelf is rotatable about the extendible arm. In various embodiments, the rotatable shelf may be configured to receive a portable electronic device (PED).

In various embodiments, the rotatable shelf may be configured to receive the PED into an elongated slot extending into a top surface of the rotatable shelf.

In various embodiments, the rotatable shelf may further comprise a depressed surface extending into the top surface. In various embodiments, the elongated slot may have a greater depth than the top surface.

In various embodiments, the rotatable shelf may be configured to receive the PED into an electronic device shelf rotatable from a bottom side of the rotatable shelf.

In various embodiments, the rotatable shelf may be configured to receive the PED into an angled indentation on a first side of the rotatable shelf and into a dropdown shelf extending from an opposing side of the rotatable shelf.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an aircraft, in accordance with various embodiments;

FIG. 2 illustrates an aircraft floorplan with a wheelchair plinth, in accordance with various embodiments;

FIG. 3 illustrates a tray table in a stowed position, in accordance with various embodiments;

FIG. 4 illustrates a tray table, in accordance with various embodiments;

FIG. 5 illustrates a tray table, in accordance with various embodiments;

FIG. 6 illustrates a tray table in a first deployed position, in accordance with various embodiments;

FIG. 7 illustrates a tray table in a second deployed position, in accordance with various embodiments;

FIG. 8 illustrates a tray table in a third deployed position, in accordance with various embodiments;

FIG. 9 illustrates a tray table, in accordance with various embodiments;

FIGS. 10A and 10B illustrate a cross-sectional view of a slot within a tray table, in accordance with various embodiments;

FIG. 11 illustrates a portable electronic device disposed in a tray table, in accordance with various embodiments; and

FIG. 12 illustrates a tray table extended in front of a user, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to “singular” includes plural embodiments, and any reference to “more than one” component or step may include a singular embodiment or step. Also, any reference to “attached,” “fixed,” “connected,” or the like may include permanent, removable, temporary, partial, full or any other possible attachment option. Additionally, any reference to “without contact” (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values and all ranges and ratio limits disclosed herein may be combined.

Aircraft passengers are increasingly using personal electronic devices in aircraft seats. It is desirable to have a hands-free, approximately eye-level shelf or perch for such devices that secures the device while positioning the device at an ideal angle for comfortable viewing. However, typical tray tables and/or electronic device shelves are disposed within seat backs. Such an arrangement limits deployment of tray tables and/or electronic device shelves for passengers seated near monuments. Accordingly, improved tray tables and/or electronic device shelves for deployment from aircraft monuments are desirable.

In various embodiments, the present disclosure provides for a tray table deployable from an aircraft monument. The tray table may comprise an elongated slot designed to hold personal electronic devices (PEDs) such as smartphones, tablets, or e-readers securely during the flight.

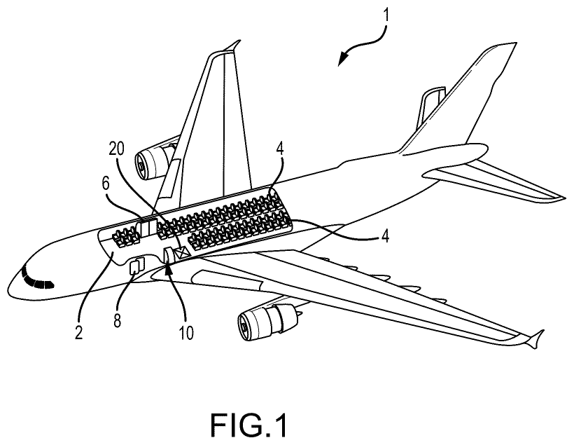

With initial reference to FIG. 1, an aircraft 1 is illustrated, in accordance with various embodiments. Aircraft 1 may comprise an aisle 2. Aircraft 1 may comprise a plurality of seats 4. Aircraft 1 may comprise one or more lavatories 6. Aircraft 1 may comprise a door 8. Aircraft 1 may comprise a monument 10. Aircraft 1 may comprise a wheelchair plinth 20. Wheelchair plinth 20 may be disposed proximate door 8. Wheelchair plinth 20 may be disposed proximate monument 10. Monument 10 may be disposed proximate passenger seating disposed immediately aft of an open space.

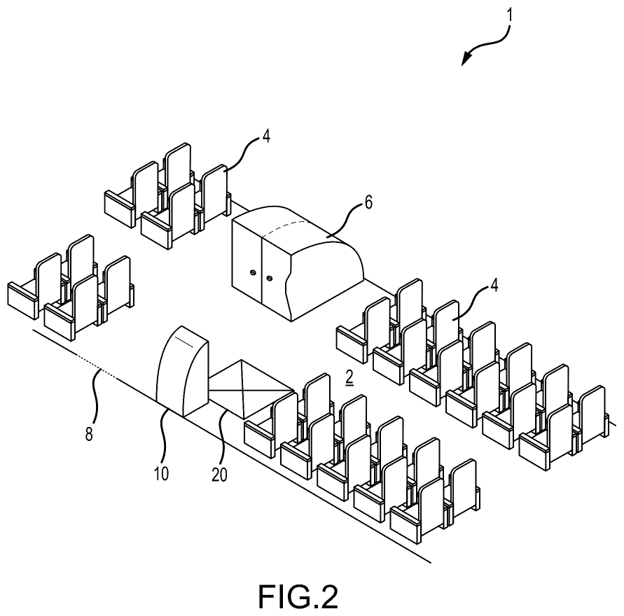

With initial reference to FIG. 2, a floor plan of aircraft 1 is illustrated, in accordance with various embodiments. As illustrated, wheelchair plinth 20 and monument 10 are disposed aft of door 8. However, it should be understood that wheelchair plinth and/or monument 10 may be disposed at any location within aircraft 1. As illustrated, monument 10 is disposed outboard of wheelchair plinth 20 and face inboard toward aisle 2. However, it should be understood that monument 10 may be disposed inboard of wheelchair plinth 20 and face outboard toward wheelchair plinth 20. While described as proximate a wheelchair plinth 20, it should be understood that monument may instead be disposed proximate an open space in the aircraft 1 or proximate passenger seating disposed immediately aft of an open space.

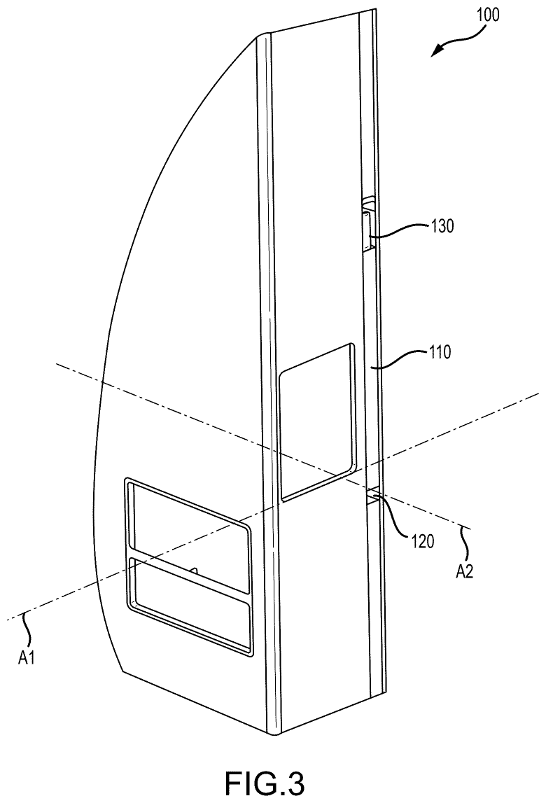

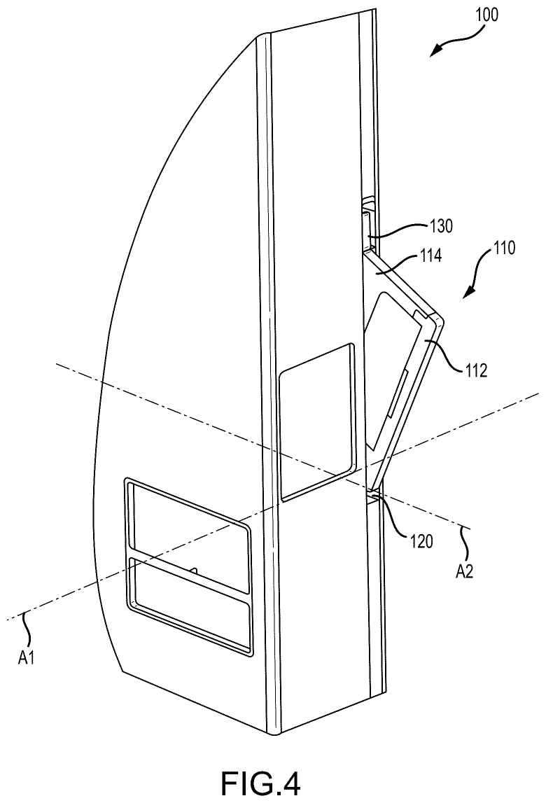

With reference to FIGS. 3-8, a monument 100 is illustrated. Monument 100 may be an aircraft monument similar to monument 10. Monument 100 may comprise a tray table 110. Tray table 110 may stowable within monument 100. Tray table 110 may be rotatable from monument 100. Monument 100 may comprise a latch 130 for retaining the tray table 110 in a stowed position, as illustrated in FIG. 3. Monument 100 may comprise a first hinge 120 about which tray table 110 may rotate to extend from monument 100. As best illustrated in FIGS. 4-7, tray table 110 may comprise a rotatable shelf 114 and an extendible arm 112. Rotatable shelf 114 may be disposed on an end of the extendible arm 112. Rotatable shelf 114 may be coupled to the extendible arm 112 on a longitudinal edge 106 of the rotatable shelf 114. The extendible arm 112 may protrude beyond a proximate end 105 of the rotatable shelf 114. The extendible arm 112 may terminate at a distal end 107 of the rotatable shelf 114.

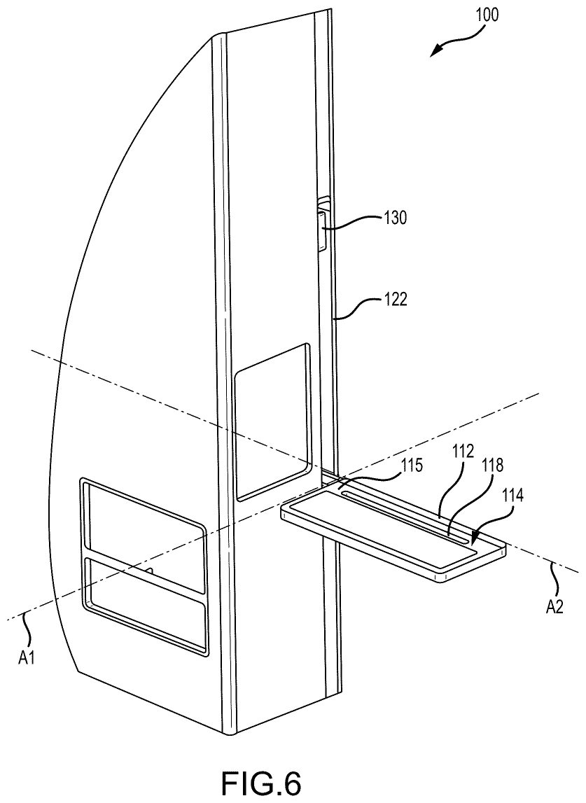

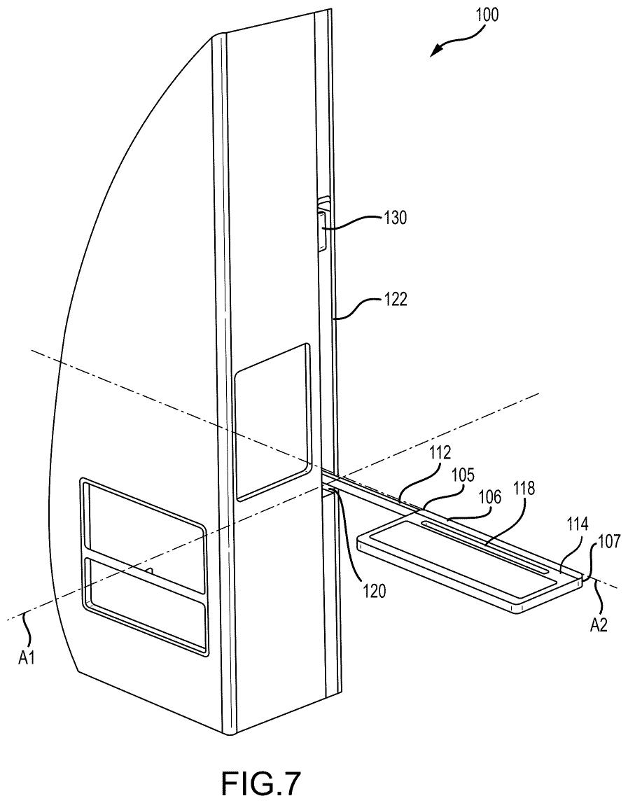

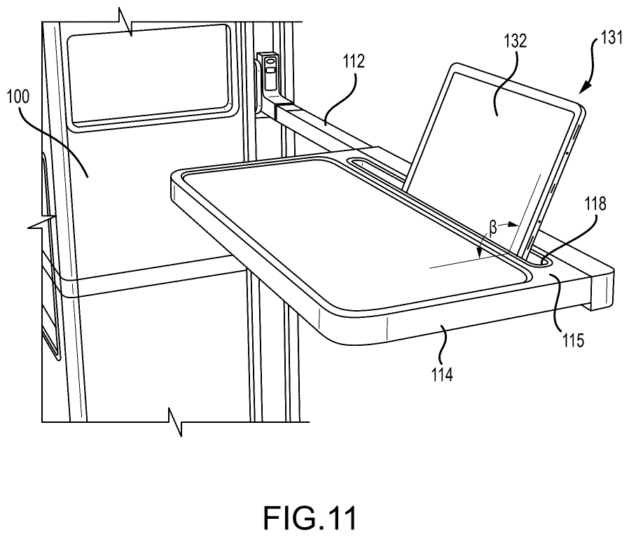

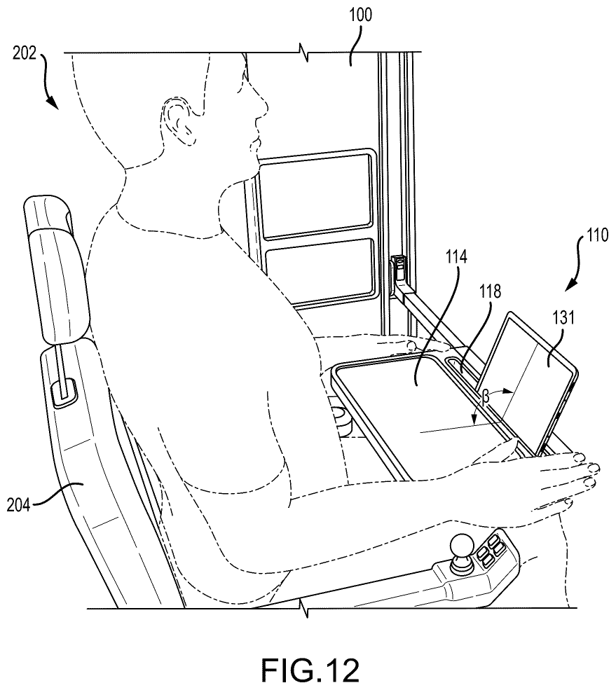

As best illustrated in FIGS. 6 and 7, tray table 110 may comprise an elongated slot 118 disposed on a top surface 115 of a rotatable shelf 114. In various embodiments, the elongated slot 118 may provide for optimal viewing angles of a PED 131 received into elongated slot 118, as best shown in FIGS. 11 and 12. The elongated slot 118 may provide for hands-free operation or viewing of a PED 131 received into elongated slot 118. In various embodiments, the elongated slot 118 may be an angled indentation extending into the top surface 115 of the rotatable shelf 114. The elongated slot 118 is versatile in that it may be compatible with state-of-the-art electronics as well as backward compatible with older technologies.

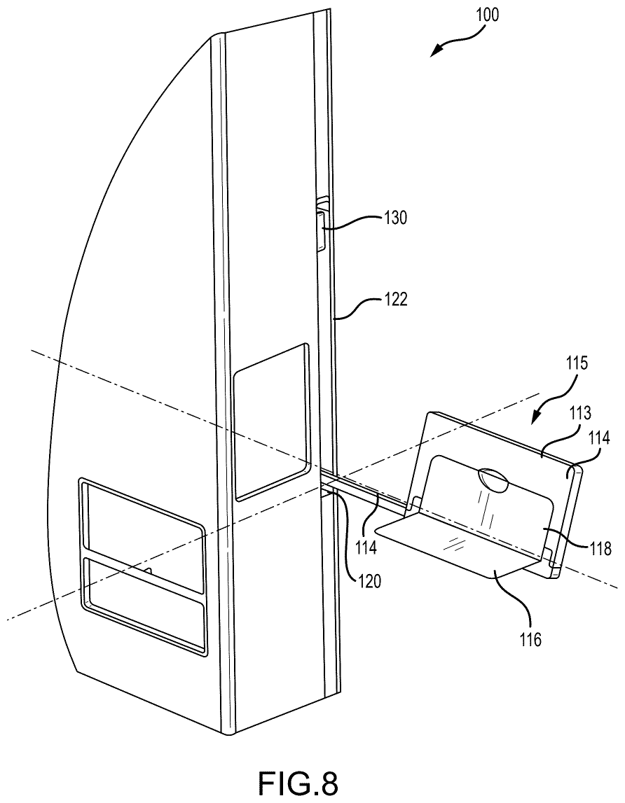

As best illustrated in FIG. 8, tray table 110 may comprise an electronic device shelf 116 disposed on a bottom side 113 of a rotatable shelf 114. While illustrated as having an electronic device shelf 116, the disclosure is not limited in this regard. It should be understood that tray table 110 may instead comprise a bottom side 113 that is flat or a bottom side 113 having different features. In various embodiments, the electronic device shelf 116 may provide for optimal viewing angles of a PED 131 received into elongated slot 118. The electronic device shelf 116 may provide for hands-free operation or viewing of a PED 131 received into the electronic device shelf 116. In various embodiments, the electronic device shelf 116 may be a dropdown shelf extending from the bottom side 113 of the rotatable shelf 114. The electronic device shelf 116 is versatile in that it may be compatible with state-of-the-art electronics as well as backward compatible with older technologies.

As shown in FIG. 4, tray table 110 may rotate about a first axis A1 defined by the first hinge 120 to extend from monument 100. In various embodiments, the extendible arm 112 of tray table 110 may rotate about the first axis A1 to extend the rotatable shelf 114 from monument 100. Tray table 110 and/or extendible arm 112 may be free to rotate about the first axis A1 in response to latch 130 being released.

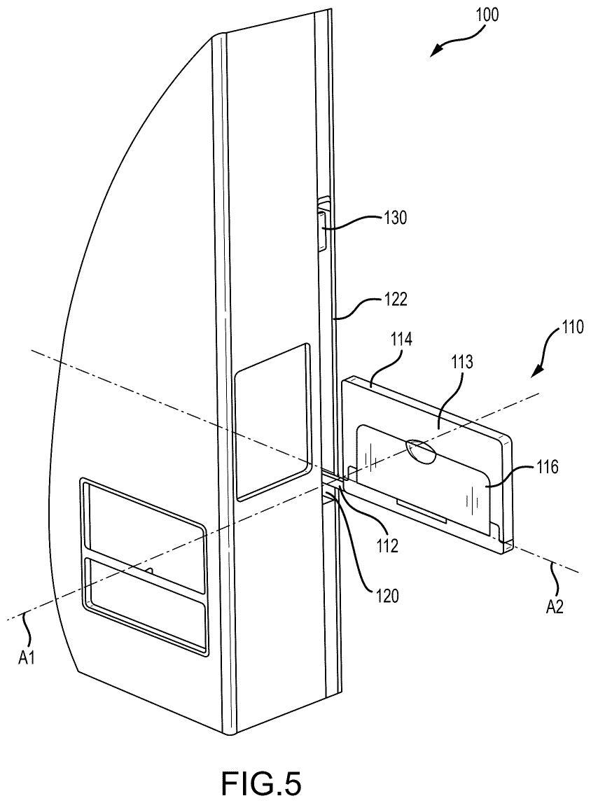

As shown in FIG. 5, tray table 110 is illustrated in a first deployed position. In the first deployed position, the tray table 110 may be rotated from monument 100 until the extendible arm 112 is in a horizontal position. In various embodiments, tray table 110 may be rotated from monument 100 until the extendible arm 112 is in a parallel to the aisle 2 of aircraft 1 (and/or perpendicular to the monument 100). When tray table 110 is rotated from monument 100 (or when prepared to be rotated into the monument 100), the extendible arm 112 is in a collapsed position and the rotatable shelf 114 is in a vertical position. When in the collapsed position, the extendible arm 112 is shortened such that the rotatable shelf 114 is disposed proximate the monument. When the extendible arm 112 is in the collapsed position, the tray table 110 is shortened such that the tray table 110 may be rotated into a vertical pocket 122 of the monument 100 and into the stowed position. When rotated into the vertical pocket 122, tray table 110 may be configured to be discreetly retained within the vertical pocket 122 such that the tray table 110 does not extend beyond a profile of the monument 100. In other words, in the stowed position, the tray table 110 is fully retained within the monument 100.

As depicted in FIG. 5, the electronic device shelf 116 is in a closed position in which the electronic device shelf 116 is retracted into the bottom side 113 of the rotatable shelf 114. However, it should be understood that the electronic device shelf 116 may be rotated to an open position, as described further herein. In the open position, the electronic device shelf 116 may be generally perpendicular to the bottom side 113 of the rotatable shelf 114. In the open position, the electronic device shelf 116 may be disposed at an obtuse angle to the bottom side 113 of the rotatable shelf 114. In the open position, the electronic device shelf 116 may be rotated between 90 degrees and 180 degrees from the bottom side 113 of the rotatable shelf 114. In the open position, the electronic device shelf 116 may be rotated between 90 degrees and 135 degrees from the bottom side 113 of the rotatable shelf 114.

As shown in FIG. 6, tray table 110 is illustrated in a second deployed position with the extendible arm 112 is in a collapsed position and the rotatable shelf 114 is in a horizontal position. Tray table 110 may rotate about a second axis A2 defined by a main hinge, described in more detail below, between a horizontal position (shown in FIG. 6), a vertical position (shown in FIG. 5), and an obtuse position (shown in FIG. 8). Second axis A2 may be perpendicular to first axis A1. The tray table 110 may be parallel to the floor of the aisle 2. In this manner, the tray table 110 may be used as a surface by a crewmember and/or a passenger seated in the wheelchair plinth 20.

As shown in FIG. 7, tray table 110 is illustrated in a second deployed position with the extendible arm 112 is in an extended position and the rotatable shelf 114 is in a horizontal position. In various embodiments, the extendible arm 112 may extend between discrete positions along the length of the extendible arm 112. In various embodiments, the extendible arm 112 may extend continuously along the length of the extendible arm 112. In this manner, the extendible arm 112 may be adjusted to a position of a passenger seated in the wheelchair plinth 20. In response to tray table 110 is illustrated in a second deployed position with the rotatable shelf 114 in a horizontal position, the elongated slot 118 is available for use by a passenger.

As shown in FIG. 8, tray table 110 is illustrated in a third deployed position in which the rotatable shelf 114 is rotated to a vertical position and the electronic device shelf 116 is available for use by a passenger. In various embodiments, the rotatable shelf 114 may be rotated past a vertical position to an obtuse position and the electronic device shelf 116 may be in an open position. In various embodiments, in the obtuse position, the rotatable shelf 114 may be at an obtuse angle with respect to the electronic device shelf 116. In the third deployed position, rotatable shelf 114 may be rotated from the second deployed position between 90 degrees and 180 degrees about the extendible arm. In the third deployed position, rotatable shelf 114 may be rotated from the second deployed position between 90 degrees and 135 degrees about the extendible arm.

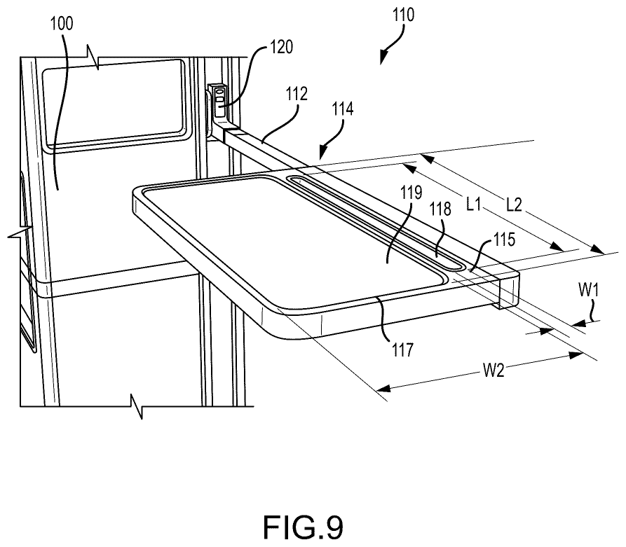

With respect to FIG. 9, tray table 110 is illustrated. In various embodiments, the top surface 115 of rotatable shelf 114 comprises various indentations. In various embodiments, the top surface 115 comprises an elongated slot 118 in the form of an angled indentation extending into the top surface 115 of the rotatable shelf 114. The elongated slot 118 may be disposed parallel to the second axis A2. The elongated slot 118 may be disposed proximate the extendible arm 112. The elongated slot 118 may be defined by a first length L1 and a first width W1. The first width W1 may be between 0.2 inches and 1.0 inches. The first width W1 may be between 0.3 inches and 0.85 inches. The first width W1 may be between 0.4 inches and 0.6 inches.

In various embodiments, the top surface 115 of rotatable shelf 114 comprises a depressed surface 119. The depressed surface 119 may be bounded by a perimeter 117 defined by the top surface 115. The perimeter 117 may be a chamfered perimeter, a beveled perimeter, or rounded perimeter, or otherwise angled from the top surface 115 to the depressed surface 119. The depressed surface 119 may be spaced from the elongated slot 118. The depressed surface 119 may be defined by a second length L2 and a second width W2. The depressed surface 119 may be recessed to a first depth D1 measured from the top surface 115. The first depth D1 may be between 0.0625 inches of an inch to 0.500 inches. The first depth D1 may be between 0.100 inches of an inch to 0.400 inches. The first depth D1 may be between 0.120 inches of an inch to 0.200 inches. In various embodiments, the depressed surface 119 is flush with the top surface 115 and perimeter 117 is a material break between depressed surface 119 and top surface 115. The second width W2 may be greater than the first width W1. In various embodiments, the second length L2 is greater than the first length L1. In various embodiments, the second length L2 is equal to the first length L1. In various embodiments, the first length L1 is greater than the second length L2. The depressed surface 119 may be configured to objects with a larger resting surface area, such as food, containers, beverages, books, papers, laptop computers, etc.

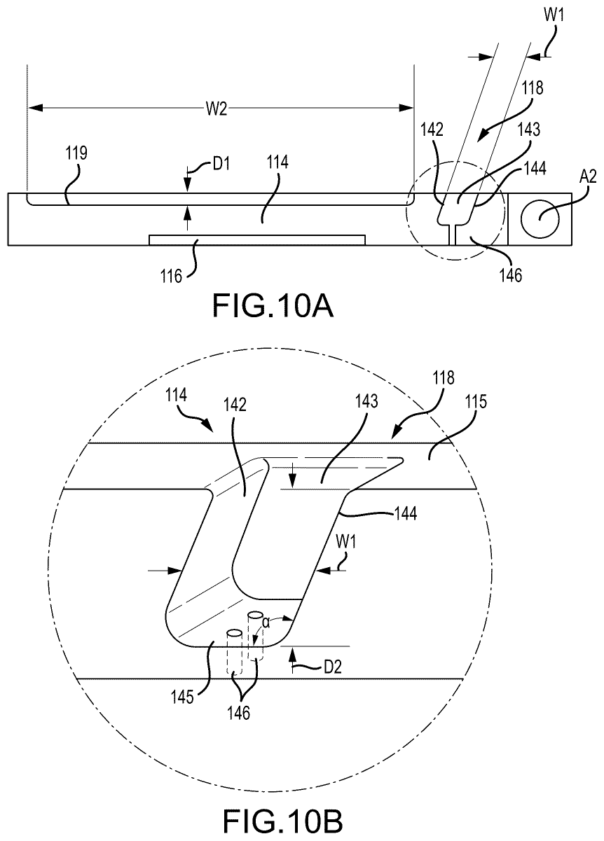

With additional reference to FIGS. 10A and 10B, a cross-sectional view of tray table 110 is illustrated. The elongated slot 118 may comprise a first longitudinal wall 142 opposing a second longitudinal wall 144. An end wall 143 may couple the first longitudinal wall 142 and the second longitudinal wall 144 on either side. The elongated slot 118 may comprise a bottom surface 145. In various embodiments, the bottom surface 145 may be generally parallel to the top surface 115. In various embodiments, the bottom surface 145 may be generally angled away from the top surface 115.

In various embodiments, each end wall 143 may form an angle with each of the first longitudinal wall 142 and the second longitudinal wall 144. Each end wall 143 may form an rounded edge with each of the first longitudinal wall 142 and the second longitudinal wall 144. In various embodiments, the first longitudinal wall 142 may be disposed further from the second axis A2 than the second longitudinal wall 144. In various embodiments, the first longitudinal wall 142 may form an acute angle with the top surface 115 of the rotatable shelf 114. In various embodiments, the second longitudinal wall 144 may form an obtuse angle with the top surface 115 of the rotatable shelf 114. In this manner, the elongated slot 118 may angle a PED 131 received into elongated slot 118 toward a passenger's line of sight, as further illustrated in FIGS. 11 and 12.

In various embodiments, the elongated slot 118 is defined by a second depth D2. The second depth D2 may extend from the top surface 115 to the bottom surface 145. The second depth D2 may be between 0.25 inches and 2.0 inches. The second depth D2 may be between 0.4 inches and 1.0 inches. The second depth D2 may be between 0.5 inches and 0.75 inches.

In various embodiments, an internal angle α is formed between the bottom surface 145 and the second longitudinal wall 144. In various embodiments, the internal angle α is between 90 degrees and 130 degrees. In various embodiments, the internal angle α is between 100 degrees and 120 degrees. In various embodiments, the internal angle α is between 105 degrees and 115 degrees.

In various embodiments, the elongated slot may comprise one or more drainage holes 146. The drainage holes 146 may be through holes extending into the bottom surface 145 of the elongated slot 118. The drainage holes 146 may be disposed longitudinally along the elongated slot 118. The drainage holes 146 may allow for spilled liquid and/or debris to pass through the bottom surface 145 of the elongated slot 118.

With respect to FIG. 11, a PED 131 is illustrated as received into the elongated slot 118 of tray table 110. A front display 132 of the PED 131 is angled away from the top surface 115 of the rotatable shelf 114. The front display 132 of the PED 131 is angled at a display angle β from the top surface 115. The display angle β may be between 90 degrees and 180 degrees. The display angle β may be between 90 degrees and 150 degrees. The display angle β may be between 95 degrees and 135 degrees.

With respect to FIG. 12, a passenger 202 is illustrated in relation to the tray table 110. The passenger 202 may be seated in a wheelchair 204 (or other mobility device) disposed proximate monument 100. Similar to the illustration of FIG. 11, a PED 131 is received into the elongated slot 118 of the rotatable shelf 114. The PED 131 is angled toward the line-of-sight of the passenger 202 at the display angle β.

Finally, it should be noted that while this disclosure is directed primarily to a tray table deployed from an aircraft monument, that the concepts described above can also be applied to tray tables deployed from alternate structures or at alternate angles. For example, tray tables 110 may be configured to extend from an alternative structure such as a galley, seats, etc.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” or “at least one of A, B, and C” is used in the specification or claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. An aircraft monument, comprising:
a tray table having an extendible arm configured to rotate about a first axis between a stowed position and a deployed position, a rotatable shelf coupled to the extendible arm and configured to rotate about a second axis perpendicular to the first axis, and an elongated slot extending into a top surface of the rotatable shelf.

2. The aircraft monument of claim 1, wherein the elongated slot is disposed parallel to the second axis and comprises a plurality of drainage holes.

3. The aircraft monument of claim 1, wherein the elongated slot has a first longitudinal wall, a second longitudinal wall, and a pair of end walls each coupling the first longitudinal wall to the second longitudinal wall, wherein the second longitudinal wall forms an obtuse angle with the top surface.

4. The aircraft monument of claim 1, further comprising an electronic device shelf disposed on a bottom side of the rotatable shelf.

5. The aircraft monument of claim 1, further comprising a depressed surface, wherein the elongated slot is disposed between the depressed surface and the second axis.

6. The aircraft monument of claim 5, wherein the depressed surface has a first depth and the elongated slot has a second depth, the second depth being greater than the first depth.

7. The aircraft monument of claim 6, wherein a perimeter of the depressed surface is defined by the top surface of the rotatable shelf.

8. The aircraft monument of claim 1, wherein, in response to being rotated about the first axis to a horizontal position, the extendible arm is extendible along the second axis.

9. An aircraft monument, comprising:
a tray table rotatable about a first axis between a stowed position and a first deployed position and configured to receive a portable electronic device (PED); and
a vertical pocket configured to stow the tray table in a stowed position.

10. The aircraft monument of claim 9, wherein the tray table is configured to receive the PED into an elongated slot extending into a top surface of the tray table.

11. The aircraft monument of claim 10, wherein the tray table is configured to receive the PED into an electronic device shelf rotatable from a bottom side of the tray table.

12. The aircraft monument of claim 9, wherein, in response to being rotated to the first deployed position, the tray table is rotatable about a second axis between a horizontal position and an obtuse position.

13. The aircraft monument of claim 10, further comprising a depressed surface extending into the top surface, the depressed surface spaced from the elongated slot.

14. The aircraft monument of claim 13, wherein the top surface defines a perimeter of the depressed surface.

15. The aircraft monument of claim 13, wherein the depressed surface has a greater width than the elongated slot, and wherein the elongated slot has a greater depth than the depressed surface.

16. A tray table system, comprising:
an extendible arm; and
a rotatable shelf coupled to the extendible arm along a longitudinal edge of the rotatable shelf such that the extendible arm protrudes beyond a proximate end of the rotatable shelf and terminates at a distal end of the rotatable shelf and such that the rotatable shelf is rotatable about the extendible arm, wherein the rotatable shelf is configured to receive a portable electronic device (PED).

17. The tray table system of claim 16, wherein the rotatable shelf is configured to receive the PED into an elongated slot extending into a top surface of the rotatable shelf.

18. The tray table system of claim 17, wherein the rotatable shelf further comprises a depressed surface extending into the top surface, wherein the elongated slot has a greater depth than the top surface.

19. The tray table system of claim 16, wherein the rotatable shelf is configured to receive the PED into an electronic device shelf rotatable from a bottom side of the rotatable shelf.

20. The tray table system of claim 16, wherein the rotatable shelf is configured to receive the PED into an angled indentation on a first side of the rotatable shelf and into a dropdown shelf extending from an opposing side of the rotatable shelf.
